(19) United States
(12) Patent Application Publication
(10) Pub. No.: US 2025/0192556 A1
(43) Pub. Date: Jun. 12, 2025

(54) ACTIVE AND REACTIVE POWER SERVICE MANAGEMENT

(71) Applicant: KRAKEN TECHNOLOGIES LIMITED, London (GB)

(72) Inventor: Nicholas GOOD, Clitheroe (GB)

(73) Assignee: KRAKEN TECHNOLOGIES LIMITED, London (GB)

(21) Appl. No.: 18/845,269

(22) PCT Filed: Feb. 27, 2023
(86) PCT No.: PCT/GB2023/050434

§ 371 Date: Sep. 9, 2024

(30) Foreign Application Priority Data
Mar. 11, 2022 (GB) 2203445.8

(51) Int. Cl. H02J 3/18; G05B 15/02

(52) U.S. Cl. CPC H02J 3/18; G05B 15/02

(57) ABSTRACT

There is provided a computer-implemented method of controlling provision of a reactive power service by an inverter-connected device in an electrical power network, the inverter having a maximum permitted apparent power Sₘₐₓ, the method comprising using a mixed integer linear programming model configured to encode the inequality Sₘₐₓ2≥P²+Q², where P is active power and Q is reactive power, by approximating the circle defined by the inequality as an n-sided polygon. The method can also be used in controlling the system frequency of the power network. Also provided is a reactive power device for an electrical power supply network, the device having an inverter, the inverter having a maximum permitted apparent power Sₘₐₓ, operatively connected to a computing arrangement configured to run a mixed integer linear programming model that performs the method.

### TECHNICAL FIELD

The present invention relates to the provision and management of active and reactive power services, that is providing active and reactive power to, and absorbing active and reactive power from, electrical power networks and to corresponding methods and installations.

### BACKGROUND

Electrical power distribution systems typically distribute electricity in the form of alternating current. This gives rise to the issue of reactive power, which is power that arises when the current waveform is out of phase with the voltage waveform as the result of either a capacitive or inductive load. Reactive power (measured in volt-amperes reactive) is distinct from active power (also known as true or real power) which is measured in Watts, and the combination of active power and reactive power gives rise to what is known as apparent power (measured in volt-amperes). Because apparent power is defined as the square root of the sum of the squares of active and reactive power, and hence is of a magnitude greater than or equal to either active or reactive power, it can give rise to overloads in cables and other transmission equipment designed to handle true power. Such overloads can lead to power outages directly, through failure or overload protection, or through the turning off of reactive power-generating power generation/consumption installations in order to reduce network loads. But generation/absorption of reactive power can also help to maintain network voltage levels, and hence increase the effective capacity of a transmission system without the need to upgrade network infrastructure. Consequently, operators of power distribution systems, such as Regional Transmission Organisations in the US, and in the UK the National Grid and UK Power Networks, need to manage both active power and reactive power. In practice this means managing reactive power by using power generators or power consumers to generate or absorb reactive power to/from the network, as required. Elements of the power supply system, such as transformers, can also be controlled to switch between absorbing or generating reactive power. One of the problems with reactive power is that it doesn't travel as far through a network as active power, and therefore if one is to control reactive power one needs to distribute reactive power management throughout the network.

Historically, most electrical power was generated using inductive generators, such as turbines, powered using fossil fuels such as coal and lignite. Concerns about global warming and pollution have led to the closure of many traditional generating stations, and this has been balanced somewhat by the introduction of electricity generation based on renewables, commonly in the form of wind turbines or photovoltaics. Typically, renewable energy installations produce less power than traditional power generation facilities and are often more remote from the ultimate consumers of the electricity generated than are traditional power generation stations. Consequently, renewable power generation facilities are often referred to as Distributed Energy Resources (DERs). One problematic consequence of this move from traditional power generation to generation based on renewable energy sources is the loss of a significant amount of capacity to absorb reactive energy. With the continuing shift away from fossil fuel power generation to renewables, this problem is only set to get worse.

In the UK, National Grid ESO and UK Power Networks are leading “The Power Potential Project” which aims to create a new reactive power market for distributed energy resources in South East England. The goal is to save consumers over £400 million by 2050, as well as generating up to an additional 4 GW. The project focuses on two aspects: active power generation; and reactive power generated or absorbed. The project literature explains that:

“The active power service relates to the active power generated from the participating DER plant. It will need to be capable of automatically ramping up or down the active power generated according to instruction, and within the plant limitations. This service is expected to help improve the management of system constraints. It will be exercised depending on the cost compared to other options in the area.

Providing this service means the plant should be ready to change its active power output upon an instruction from UK Power Networks. The plant response should be automatic and within its pre-defined limits and ramp rates.”

Whereas the reactive power service “relates to the reactive power generated or absorbed by the participating DER plant. This production/absorption of reactive power would allow more effective control of the voltage in the distribution and transmission systems. To do this, an automatic response enabled through a voltage droop control is required. This control system will automatically respond to voltage changes measured at the point of connection. Any change in voltage target set point received electronically should be acted on within two seconds.”.

In order to be able to work efficiently and profitably under this set of requirements, operators of installations providing reactive power services, and especially operators of installations providing both active and reactive power services, will need to be able to control their installations appropriately—and sustained profitability is likely to require the provision of such services to be optimised under the various practical constraints that exist.

Embodiments of the present invention seek to provide a solution, in whole or in part, to this problem.

### SUMMARY

According to a first aspect, there is provided a computer-implemented method of controlling provision of active and reactive power services from a device in an electrical power network which can both generate and absorb/consume active and reactive power, and which has a maximum permitted apparent power Sₘₐₓ, comprising:
performing an optimisation according to the inequality Sₘₐₓ²≥P²+Q² using a mixed integer linear programming model which is applied to a series of linear constraints which each intersect the circle defined by the inequality, the series of linear constraints having been selected to approximate the circle defined by the inequality as an n-sided polygon.
   Inverter-connected device are prime examples of such devices.

According to a second aspect, there is provided a computer-implemented method of controlling active and reactive power absorption by, and active and reactive power supply from, a device in an electrical power network, the device having a maximum permitted apparent power Sₘₐₓ, the method comprising using a mixed integer linear programming model configured to encode the inequality Sₘₐₓ²≥P²+Q², where P is active power and Q is reactive power, by approximating the circle defined by the inequality as an n-sided polygon.

Preferably the MILP model of the second aspect uses a set of linear constraints, the linear constraints having been defined with values of P and Q, each linear constraint defining a secant of the circle described by the inequality S²≥P²+Q², where S is less than or equal to Sₘₐₓ, the secants together defining an n-sided polygon whose apexes lie on the circumference of the circle. Preferably S is at least 90 to 99% of Sₘₐₓ. More preferably, S²=Sₘₐₓ².

Optionally, the set of linear constraints are:

$$( Q - {S}_{max} cos ( ( b - 1 ) π / {N}_{b} ) ) ( ( sin ( b π / {N}_{b} ) - sin ( ( b - 1 ) π / {N}_{b} ) ) / ( cos ( b π / {N}_{b} ) - cos ( ( b - 1 ) π / {N}_{b} ) ) ) + {S}_{max} sin ( ( b - 1 ) π / {N}_{b} ) \leq P$$

$$and$$

$$P \leq ( Q + {S}_{max} cos ( ( b - 1 ) π / {N}_{b} ) ) ( ( sin ( b π / {N}_{b} ) - sin ( ( b - 1 ) π / {N}_{b} ) ) / ( cos ( b π / {N}_{b} ) - cos ( ( b - 1 ) π / {N}_{b} ) ) ) - {S}_{max} sin ( ( b - 1 ) π / {N}_{b} )$$

Optionally, the MILP model of the second aspect uses a set of linear constraints, the linear constraints having been defined with values of P and Q, each linear constraint defining a tangent of the circle described by the inequality S²≥P²+Q², where S is less than Sₘₐₓ, the tangents together defining an n-sided polygon. Preferably S is in the range 90 to 99% of Sₘₐₓ, optionally at least 95%.

Preferably the reactive power service provided by the device comprises both absorbing reactive power from, and supplying reactive power to, the electrical power supply network. Although the method is applicable to both energy supply and reserve services, co-optimisation is particularly useful when employed to optimise reactive power reserve services (i.e., the operator of the device is paid to make the device available to provide reactive power, if required).

Preferably the MILP model is configured to co-optimise active and reactive power services of the device.

Optionally the method of any variant of the first or second aspects further comprises receiving real-time measurement data on the operating frequency of the power network (system frequency), and in response to the real-time measurement data on system frequency varying the balance between reactive and active power absorption/generation on a sub-second basis to increase/decrease active power import/export to adjust (reduce/increase) system frequency. In this way a useful contribution can be made to controlling the system frequency of the network.

According to a third aspect, there is provided a device for generating and absorbing reactive power in an electrical power supply network, the device having a maximum permitted apparent power Sₘₐₓ, operatively connected to a computing arrangement configured to run a mixed integer linear programming model that performs the method according to any variant of the first or second aspect.

According to a fourth aspect, there is provided a power installation for supplying active and reactive power to, and absorbing active and reactive power from, an electrical power supply network, the power installation including one or more devices each having a maximum permitted apparent power Sₘₐₓ, each device being operatively connected to a computing arrangement configured to run a mixed integer linear programming model that performs the method of any variant of the first or second aspect.

According to a fifth aspect, there is provided an electrical power supply network including a power installation to supply active and reactive power to, and to receive active and reactive power from, the network, the power installation including one or more inverter-connected devices, each inverter-connected device being operatively connected to a computing arrangement configured to run a mixed integer linear programming model that performs the method of any variant of the first or second aspect.

According to a sixth aspect, there is provided a computer-implemented method of defining a mixed integer linear programming model for use in co-optimising active and reactive power provision from, and absorption by, an installation in a power supply network, the installation having an apparent power maximum Sₘₐₓ which is defined by the inequality Sₘₐₓ²≥P²+Q², where P is active power and Q is reactive power, the method comprising: defining a set of linear constraints with values of P and Q, each linear constraint defining a secant of the circle described by the inequality S²≥P²+Q², where S is less than or equal to Sₘₐₓ, the secants together defining an n-sided polygon whose apexes lie on the circumference of the circle; and building a mixed integer linear programming model using the defined set of linear constraints for use in optimise reactive power provision of the installation.

According to a seventh aspect, there is provided a computer-implemented method of defining a mixed integer linear programming model for use in co-optimising active and reactive power provision from, and absorption by, an installation in a power supply network, the installation having an apparent power maximum Sₘₐₓ which is defined by the inequality Sₘₐₓ²≥P²+Q², where P is active power and Q is reactive power, the method comprising: defining a set of linear constraints with values of P and Q, the linear constraints having been defined with values of P and Q, each linear constraint defining a tangent of the circle described by the inequality S²≥P²+Q², where S is less than Sₘₐₓ, the tangents together defining an n-sided polygon.

Preferably in any of the aspects or embodiments, n is at least 10, optionally between 10 and 30 sides, optionally at least 15 or 20, optionally between 21 and 25 sides, and optionally more than 30 sides.

### BRIEF DESCRIPTION OF THE DRAWINGS

Embodiments of the invention will now be described, by way of example only, with reference to the accompanying drawings, in which:

FIG. 1 is a schematic representing a power generation and supply network of a type to which the present invention may be applied;

FIG. 2 illustrates the relationship between apparent power, reactive power, and active power; and

FIG. 3 illustrates approximating the circle that is defined by the inequality linking apparent power, reactive power, and active power, as an n-sided polygon in accordance with an aspect of the invention.

### SPECIFIC DESCRIPTION

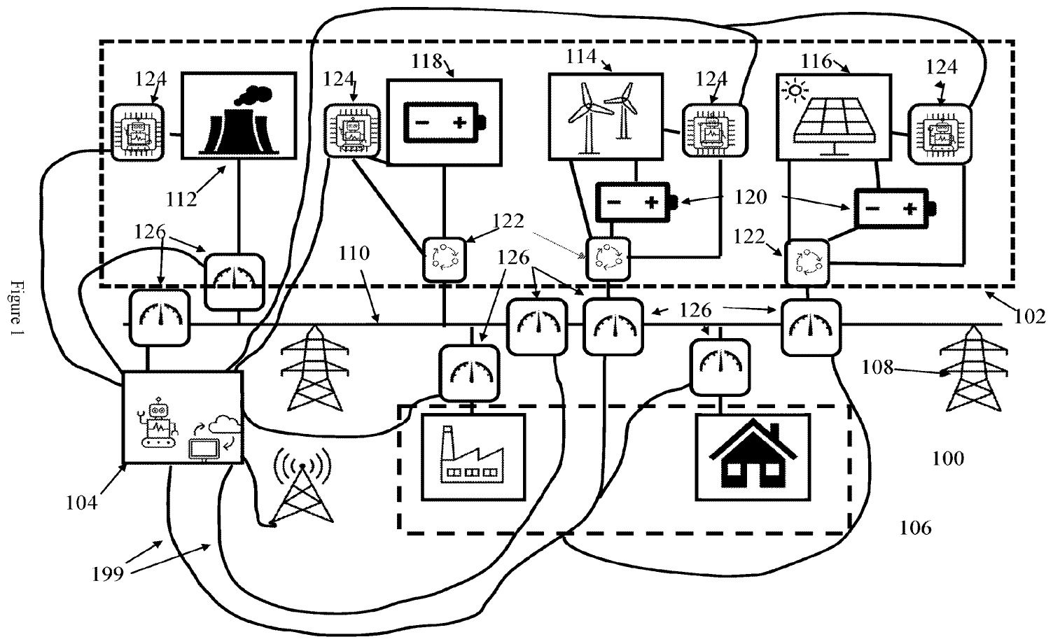

FIG. 1 illustrates schematically a power generation and supply network 100 of a type to which the present invention may be applied. The network 100, which transports electricity using alternating current (AC) according to a set system frequency, includes power generation and storage function 102, a network management function 104 operated for example by a Regional Transmission Organisation, Network Power UK, the National Grid, or the like, and electricity consumers 106. A distribution network represented by pylons 108 and cables 110, interconnects various installations of the power generation and storage function, and also connects this function to the electricity consumers 106.

The power generation and storage function 102 includes a conventional fossil fuel power station 112, and two renewable generation installations—a wind turbine installation or wind farm 114, and a solar powered installation 116, here represented as a bank of photovoltaic cells. In addition, the power generation and storage function 102 includes a power storage installation 118—here represented as a battery storage installation. The two renewable generation installations 114 and 116 may also, as shown, include power storage capability 120, for example in the form of battery storage. The power storage installation 118, and the two renewable generation installations 114 and 116, are all shown as including inverters 122 to convert direct current (DC) into alternating current for supply to the power network (and vice versa if necessary). Each of the installations of the power generation and storage function 102 includes a control centre 124 which, as shown, is computerised including one or more processors as well as possibly human operators to oversee operations.

The network 100 includes at various points measurement devices 126 configured to measure and provide the management function 104 with data on at least voltage levels, but preferably also on system frequency and reactive and active power. In particular a measurement device 126 is provided at each interconnection between a power generation or storage installation 112, 114, 116, 118, and the distribution network and these measurement devices are arranged to monitor reactive power (and the degree to which current leads or lags voltage), voltage levels and system frequency, and to provide the relevant data to the management function 104. This same information is also available to the relevant control centre 124, typically through a sensing arrangement on the installation side of the relevant measurement device 126. Preferably, the management function 104 is coupled to the measurement devices 126 using optical links provided over optical fibres 199, although there may also be radio back up—although understandably radio transmission and reception may be negatively influenced by the high voltage transmission environment. Similarly, each of the control centres 124 is also coupled to the management function 104 using optical links provided over optical fibres, for the exchange of data and control signals—for example for provision of voltage droop control.

Measurement devices 126 are preferably provided at points between major electricity consumers (such as industrial users) and the network 100, again coupled to the management function 104 via optical fibre.

Having set the scene, we will now consider the problem of controlling active and reactive power services which include the sinking or absorbing of active and reactive power from the network and/or the provision of active and reactive power to the network, and in particular the problem of optimising the sinking/supplying of both active and reactive power. Thus, we are interested in co-optimising reactive power services and active power provision where this issue arises.

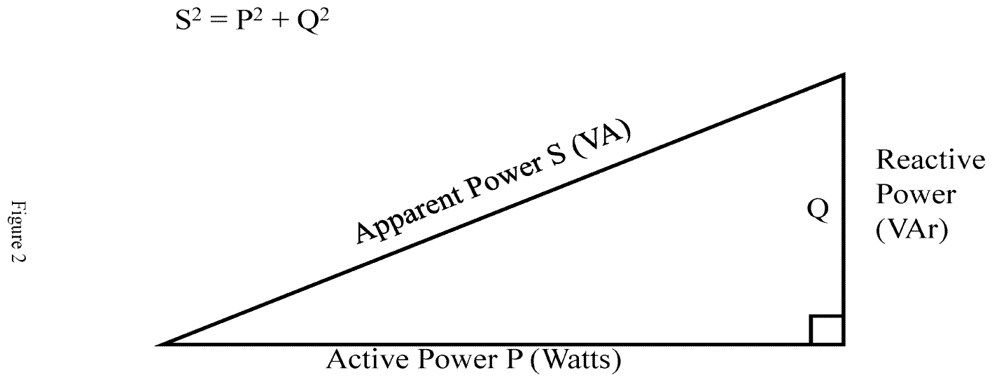

Faced with an optimisation problem many engineers will look to apply a mixed-integer linear programming (MILP) model or framework, because these provide an effective mathematical modelling approach to solve complex optimisation tasks and because they can readily be coded for, and processed on, general purpose processors. MILPs can also be programmed for multi-core processors or other parallel computing approaches to provide very impressive solution times. If we want to co-optimise active and reactive power services, in real time, using a MILP seems very attractive. But unfortunately, as illustrated in FIG. 2 the relationship between apparent power, reactive power, and active power is represented by the inequality S²≥P²+Q², where P is active power, Q is reactive power, and S is apparent power, and MILPs can't handle non-linearity.

It seems therefore that we need to find another approach to controlling, and hopefully co-optimising active and reactive power services, in real time.

But let's look again at the relationship between S, Q and P. It's remarkably like the standard equation for a circle of radius r centred at (h,k):(x−h)²+(y−k)²=r², where (h,k) are (0,0). Indeed, the inequality plots a circle with radius S with P along the x-axis, and Q along the y-axis. Although this doesn't initially sound particularly interesting, we can use this circularity in such a way that we can use an MILP to manage our control or optimisation problem.

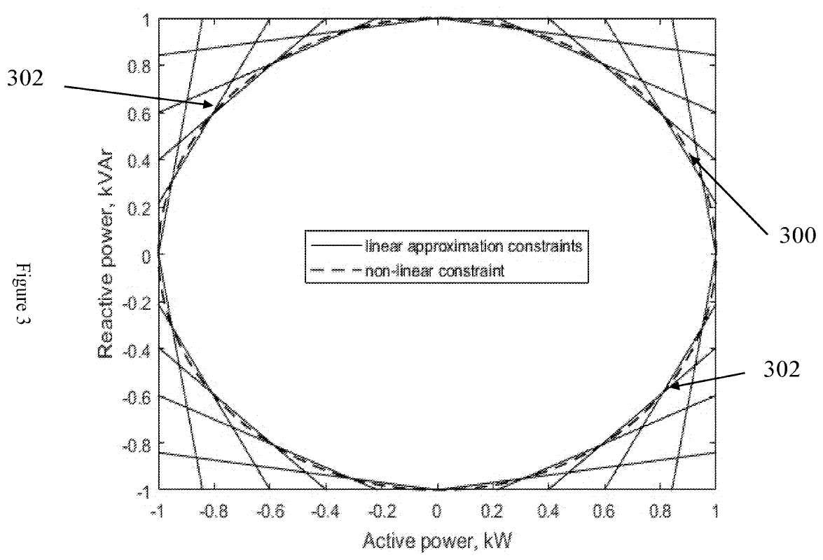

In order to be able to use an MILP we need to find suitable linear equations. Our approach is to identify linear equations that enable us to approximate the circle defined by the inequality. This approach will now be explained with reference to FIG. 3. This shows, as a dashed line, a circle 300 which represents the constraint Sₘₐₓ² corresponding to the maximum permitted apparent power Sₘₐₓ, of the device in an electrical power network. The constraint may come from the properties of an inverter that couples the device to the network but may alternatively be an inherent property of a device that connects to the network other than through an inverter. Each of the solid lines 302, which in the example shown are secants to the circle (intersecting the circumference of the circle at just two points), represents a linear approximation constraint. It will be appreciated that in this way we have defined an n-sided polygon. As shown, there are 20 linear approximation constraints-so our polygon has 20 sides (an icosagon), and in this case we have defined a regular polygon, where each side has the same length—although this is not essential. One could instead define an irregular polygon which includes sides of different lengths, although this may make the modelling somewhat more complex.

Clearly, the greater the number of sides to our polygon the closer we will get to approximating a circle. With 20 sides a regular polygon made up of secants covers approximately 98.3% of the area of the base circle (meaning that our constraints define a boundary very close to Sₘₐₓ²), with 10 sides a similar regular polygon still covers approximately 93.6%, with just 6 sides the coverage reduces to about 82.7%, whereas with 30 sides a similar regular polygon still covers approximately 99.3%. It should be appreciated that increasing the number of sides of the polygon gives a closer approximation, all other things being equal, but at the expense of greater processing complexity and hence run time: the choice of the number of sides in our polygon is a trade-off between performance (the degree of optimisation) and processing complexity. It can be seen that choosing a polygon with at least 10 sides can give a good approximation, and by the time we reach 20 sides we have a very good approximation indeed. By the time we reach 30 sides we are probably in the realm of diminishing returns where any further increase in the number of sides gives practically no additional benefit despite the increased processing complexity.

The constraints used in the example illustrated in FIG. 3 are as follows:

The constraints, which are applied for every value of b in the range (1, N_{b}), b being an integer, are:

$$( Q - {S}_{max} cos ( ( b - 1 ) π / {N}_{b} ) ) ( ( sin ( b π / {N}_{b} ) - sin ( ( b - 1 ) π / {N}_{b} ) ) / ( cos ( b π / {N}_{b} ) - cos ( ( b - 1 ) π / {N}_{b} ) ) ) + {S}_{max} sin ( ( b - 1 ) π / {N}_{b} ) \leq P$$

$$and$$

$$P \leq ( Q + {S}_{max} cos ( ( b - 1 ) π / {N}_{b} ) ) ( ( sin ( b π / {N}_{b} ) - sin ( ( b - 1 ) π / {N}_{b} ) ) / ( cos ( b π / {N}_{b} ) - cos ( ( b - 1 ) π / {N}_{b} ) ) ) - {S}_{max} sin ( ( b - 1 ) π / {N}_{b} )$$

Here N_{b} is half of the number of linear constraints which the user requires in the approximation of the non-linear constraint.

Although in the FIG. 3 example we constructed our polygon using secants of the circle Sₘₐₓ² it will be appreciated that other approaches using the same or a similar principle can also be used. For example, the circle could be defined for a value of S less than Sₘₐₓ. If the value of S is only fractionally smaller than Sₘₐₓ and the number of sides of the polygon is reasonably high (e.g. 15 to 20 or more) then the approximation to the Smax circle can still be very close. And based on this idea—of setting the size of the circle to less than that for Smax, we can consider defining linear equations that express tangents of the smaller circle, the tangents touching the inner circle at points (the points of tangency) within the Smax circle, rather than using secants.

Optionally, the tangents could be of the Smax circle to define a feasible region which is slightly larger than the feasible region defined by the non-linear constraint-which is still a useful approximation.

It will be appreciated that the secant method applied to the Smax circle encompasses a region which is slightly smaller than the feasible region defined by the non-linear constraint, but one could also apply the secant technique to a circle slightly bigger than Smax to define a feasible region which is slightly larger than the feasible region defined by the non-linear constraint. Essentially it depends on whether one prefers to be slightly over-constrained or slightly under-constrained.

Using the approximation approaches that we have described it becomes possible to control, and preferably to co-optimise the provision/absorption of active and reactive power—so that an operator of an installation that can provide active power and source or sink reactive power should be in a position to manage the installation with good, even optimum, efficiency. This applies both to situations where the installation (operator or owner) is paid for the amount of reactive power provided/absorbed, but also potentially to situations where reactive power services will be procured as a ‘reserve’-type service, i.e., in which one is paid for the capacity one retains to produce/absorb reactive power—as is proposed in the Power Potential project mentioned earlier.

Although the method is applicable to both energy supply and reserve services, co-optimisation is particularly useful when employed to optimise reactive power reserve services (i.e., the device operator is paid to make the device available to provide reactive power, if required).

Importantly, the described methods can also be used in a frequency support service. By adjusting (turn-down/up) active power as part of the co-optimisation in response to system frequency, and performed at appropriate speed (e.g., sub-secondly) a frequency support service can be provided. In this use case, the balance between reactive and active power absorption/generation would vary sub-secondly in response to real-time measurements of system frequency to increase/decrease active power import/export to help control (reduce/increase) system frequency.

1. A computer-implemented method of controlling active and reactive power absorption by, and active and reactive power supply from, a device in an electrical power network, the device having a maximum permitted apparent power Sₘₐₓ, the method comprising using a mixed integer linear programming model configured to encode the inequality Sₘₐₓ²≥P²+Q², where P is active power and Q is reactive power, by approximating the circle defined by the inequality as an n-sided polygon.

2. The method of claim 1, wherein the mixed integer linear programming model uses a set of linear constraints, the linear constraints having been defined with values of P and Q, each linear constraint defining a secant of the circle described by the inequality S²≥P²+Q², where S is less than or equal to Sₘₐₓ, the secants together defining an n-sided polygon whose apexes lie on the circumference of the circle.

3. The method of claim 2, wherein S²=Sₘₐₓ².

4. The method of claim 2 or claim 3, wherein the set of linear constraints comprises
$$( Q - {S}_{max} cos ( ( b - 1 ) π / {N}_{b} ) ) ( ( sin ( b π / {N}_{b} ) - sin ( ( b - 1 ) π / {N}_{b} ) ) / ( cos ( b π / {N}_{b} ) - cos ( ( b - 1 ) π / {N}_{b} ) ) ) + {S}_{max} sin ( ( b - 1 ) π / {N}_{b} ) \leq P$$
$$and$$
$$P \leq ( Q + {S}_{max} cos ( ( b - 1 ) π / {N}_{b} ) ) ( ( sin ( b π / {N}_{b} ) - sin ( ( b - 1 ) π / {N}_{b} ) ) / ( cos ( b π / {N}_{b} ) - cos ( ( b - 1 ) π / {N}_{b} ) ) ) - {S}_{max} sin ( ( b - 1 ) π / {N}_{b} )$$
where N_{b} is half of the number of linear constraints which the user requires in the approximation of the non-linear constraint.

5. The method of claim 1, wherein the mixed integer linear programming model uses a set of linear constraints, the linear constraints having been defined with values of P and Q, each linear constraint defining a tangent of the circle described by the inequality S²≥P²+Q², where S is less than Sₘₐₓ, the tangents together defining an n-sided polygon.

6. The method of any one of the preceding claims, wherein the mixed integer linear programming model is configured to co-optimise the device's active and reactive power supply and consumption/absorption.

7. The method of any one of the preceding claims, further comprising receiving real-time measurement data on the operating frequency of the power network, and in response to the real-time measurement data on system frequency varying the balance between reactive and active power absorption/generation on a sub-second basis to increase/decrease active power import/export to adjust system frequency.

8. A device for generating and absorbing active and reactive power in an electrical power supply network, the device having a maximum permitted apparent power Sₘₐₓ, operatively connected to a computing arrangement configured to run a mixed integer linear programming model that performs the method of any one of the preceding claims.

9. A power installation for supplying active and reactive power to, and absorbing active and reactive power from, an electrical power supply network, the power installation including one or more devices each having a maximum permitted apparent power Sₘₐₓ, each device being operatively connected to a computing arrangement configured to run a mixed integer linear programming model that performs the method of any one of claims 1 to 6.

10. A power installation for supplying active and reactive power to, and absorbing active and reactive power from, an electrical power supply network, the power installation including one or more devices each having a maximum permitted apparent power Sₘₐₓ, each device being operatively connected to a computing arrangement configured to run a mixed integer linear programming model that performs the method of claim 7 to control the operating frequency of the network.

11. The power installation of claim 9 or 10, the one or more devices each having a maximum permitted apparent power Sₘₐₓ, each being an inverter-connected device whose maximum permitted apparent power is determined by the respective inverter.

12. An electrical power supply network including a power installation to supply active and reactive power to, and to receive active and reactive power from, the network, the power installation including one or more inverter-connected devices, each inverter-connected device being operatively connected to a computing arrangement configured to run a mixed integer linear programming model that performs the method of any one of claims 1 to 6.

13. An electrical power supply network including a power installation to supply active and reactive power to, and to receive active and reactive power from, the network, the power installation including one or more inverter-connected devices, each inverter-connected device being operatively connected to a computing arrangement configured to run a mixed integer linear programming model that performs the method of claim 7 to control the operating frequency of the network.
